(19) United States
(12) Patent Application Publication
(10) Pub. No.: US 2021/0394785 A1
(43) Pub. Date: Dec. 23, 2021

(54) REMOTE MANUAL AND AUTONOMOUS WORK MACHINE CONTROL

(71) Applicant: Caterpillar Paving Products Inc., Brooklyn Park, MN (US)

(72) Inventor: Timothy M. O'Donnell, Long Lake, MN (US)

(73) Assignee: Caterpillar Paving Products Inc., Brooklyn Park, MN (US)

(21) Appl. No.: 16/905,468

(22) Filed: Jun. 18, 2020

(51) Int. Cl. B60W 60/00; G05D 1/00; B60W 10/20; B60W 10/30; B60W 10/18

(52) U.S. Cl. CPC B60W 60/005; G05D 1/0022; G05D 1/0016; B60W 10/18; B60W 10/20; B60W 10/30; B60W 60/0025

(57) ABSTRACT

A work machine remote control console includes at least one wireless communication module, a first machine user interface, and a second machine user interface. The at least one wireless communication module is configured for wireless communication with a work machine. The first machine user interface includes one or more input devices configured to receive input from an operator related to autonomous tasks of the work machine and one or more output devices configured to output information related to the autonomous tasks to the operator. The second machine user interface includes one or more input devices usable by the operator to manually control operation of the work machine. The first and second user interfaces are configured to receive information from and transmit information to the work machine via the at least one communication module.

### TECHNICAL FIELD

The present disclosure relates to systems and methods for remote machine manual and autonomous control.

### BACKGROUND

Some heavy machinery, for example, agricultural, industrial, construction or other heavy machinery include systems for controlling various aspects of the machine control via a remote interface. Remote machine control may include an operator configuring an autonomous machine task via a remote configuration, control, monitoring (etcetera) interface and sending command signal(s) to the machine to execute the operator configured and initiated autonomous task(s). Remote machine control may also include an operator manually controlling the machine via a remote interface to deal with exigent job site circumstances (e.g., object avoidance), to define new autonomous tasks, to position the machine to execute an autonomous task, and to otherwise control machine operation in circumstances not defined in or accounted for in one or more autonomous tasks of the machine.

### SUMMARY

In an example according to this disclosure, a work machine remote control console includes at least one wireless communication module, a first machine user interface, and a second machine user interface. The at least one wireless communication module is configured for wireless communication with a work machine. The first machine user interface includes one or more input devices configured to receive input from an operator related to autonomous tasks of the work machine and one or more output devices configured to output information related to the autonomous tasks to the operator. The second machine user interface includes one or more input devices usable by the operator to manually control operation of the work machine. The first and second user interfaces are configured to receive information from and transmit information to the work machine via the at least one communication module.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an elevation view depicting an example machine in accordance with this disclosure.

FIG. 2A is schematic diagram depicting an example remote manual and autonomous machine control system.

FIG. 2B depicts a first user interface of an example remote control console in accordance with this disclosure.

FIG. 2C depicts a second user interface of an example remote control console in accordance with this disclosure.

### DETAILED DESCRIPTION

Examples according to this disclosure are directed to systems and methods for remote machine manual and autonomous control. One example according to this disclosure includes a work machine remote control console. The remote control console includes at least one wireless communication module, a first machine user interface, and a second machine user interface. The at least one wireless communication module is configured for wireless communication with a work machine. The first machine user interface includes one or more input devices configured to receive input from an operator related to autonomous tasks of the work machine and one or more output devices configured to output information related to the autonomous tasks to the operator. The second machine user interface includes one or more input devices usable by the operator to manually control operation of the work machine. The first and second user interfaces are configured to receive information from and transmit information to the work machine via the at least one communication module. Thus, the example remote control console provides control, configuration, monitoring, etc. of both autonomous tasks executed by the machine without operator control/intervention and remote manual control of the work machine by a machine operator at the remote control console.

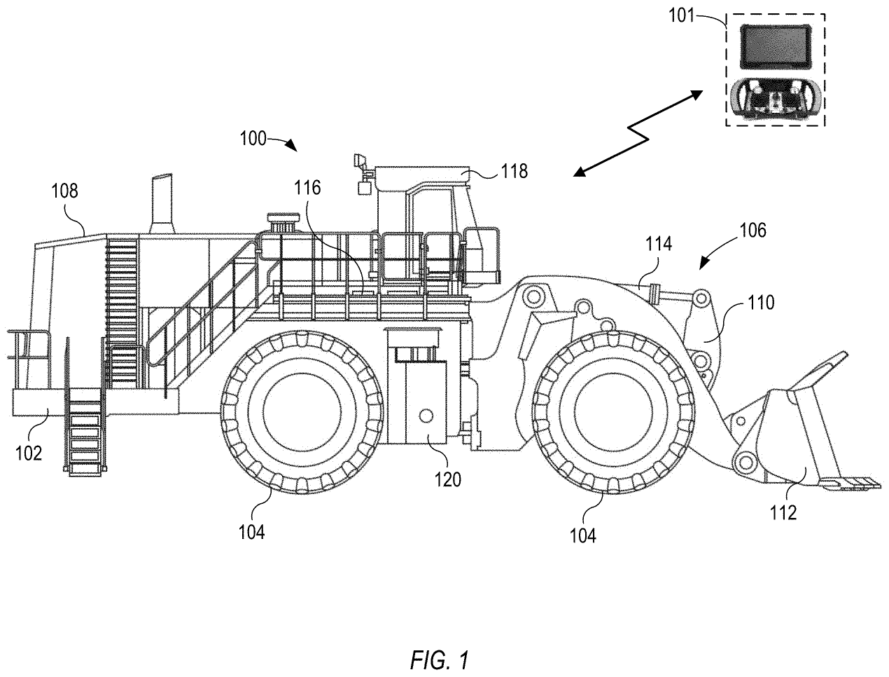

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, and so on. Accordingly, although a number of examples are described with reference to a wheel loader machine, examples according to this disclosure are also applicable to other types of machines including graders, scrapers, dozers, excavators, compactors, material haulers like dump trucks, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an engine and/or other drive system to propel the machine over various terrain via wheels 106. The engine can include various power generation platforms, including, for example, an internal combustion engine, whether gasoline or diesel.

Machine 100 includes implement 106 coupled to the frame 102 through linkage assembly 110, which is configured to be actuated to articulate bucket 112 of implement 110. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 114. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can include a tank compartment connected to frame 102 and including fuel tank 120. Fuel tank 120 is fluidly coupled to the engine. Tank 120 is configured to store a fuel therein and serve as a source for supply of the fuel to the engine of machine 100. Machine 100 may also include other tanks, for example, to store and supply hydraulic fluid to implement 106 or other components of machine 100.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. As an example, machine 100 can be used to excavate a portion of a work site by actuating cylinders 114 to articulate bucket 112 via linkage 100 to dig into and remove dirt, rock, sand, etc. from a portion of the work site and deposit this load in another location.

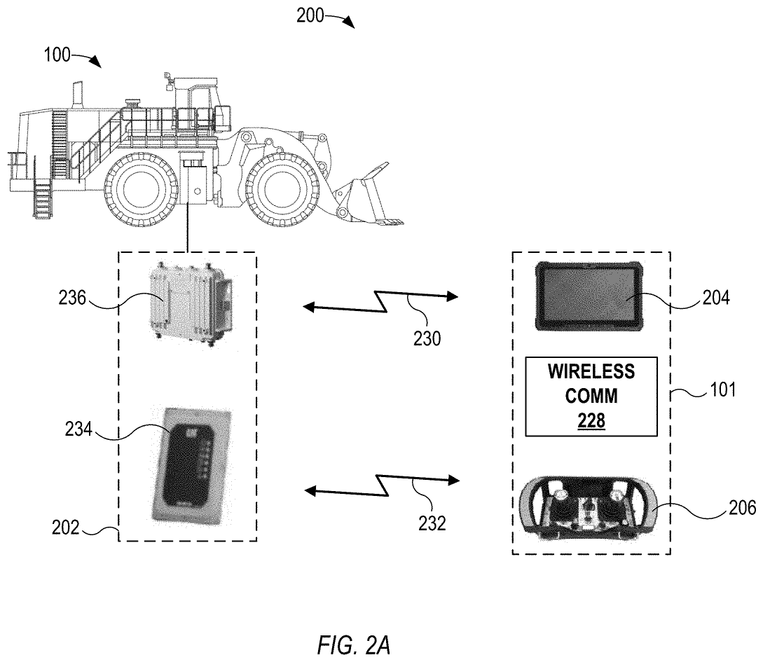

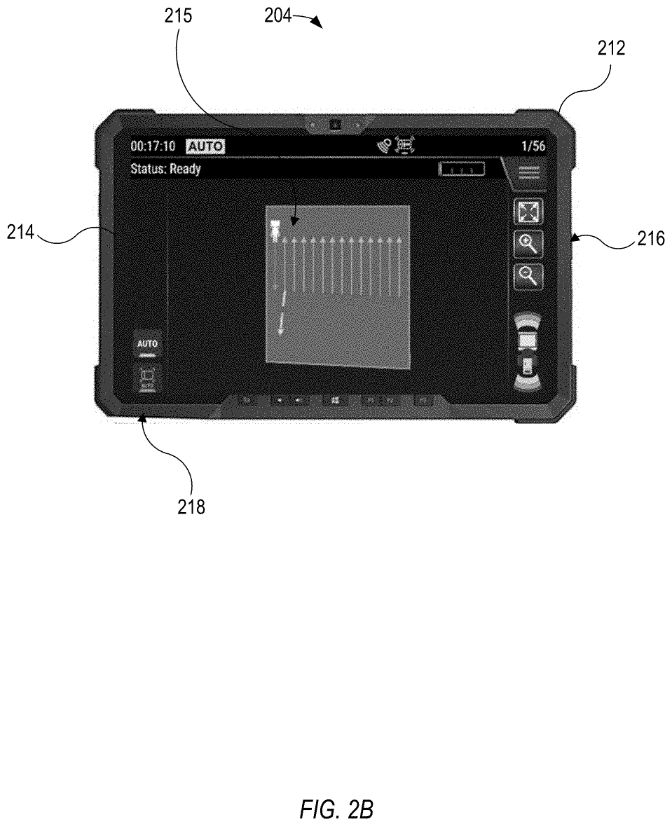

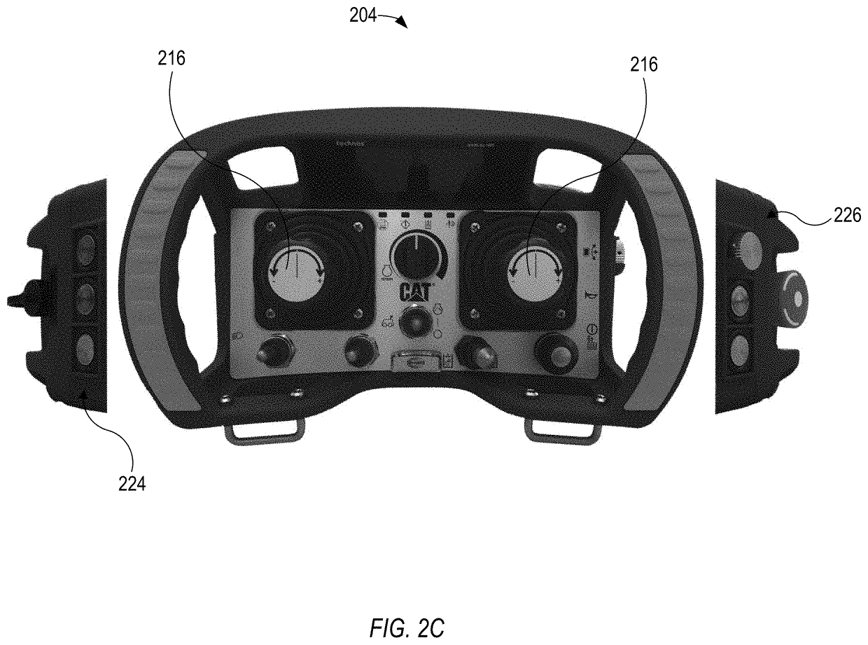

In FIG. 1, work machine 100 is wirelessly communicatively connected to remote control console 101. As described in more detail below and with reference to FIGS. 2A-2C, remote control consoles in accordance with this disclosure, including example console 101 are configured to allow a machine operator to configure and execute autonomous tasks and also to remotely manually control the machine as if seated in the machine operator cabin. Thus, in addition to traditional in-situ operation by an operator in cabin 118, machine 100 is configured to execute tasks autonomously without requiring operator input (whether in cabin 118 or otherwise).

For example, machine 100 may include one or more controllers or other digital electronics configured to control various aspects of machine operation in accordance with a stored program(s) specifying one or more construction or other types of tasks. Machine 100 can be configured to receive task instructions and to execute the task autonomously by the controller(s) processing the task instructions/program and causing various systems of machine 100 (e.g., throttle, braking, steering, implement use and articulation, etc.) to execute the task in accordance with the instructions/program. For safety and other reasons, an operator will typically monitor machine 100 executing such autonomous tasks, but, barring the need to intervene for some unexpected reason (e.g., avoid an object in machine path), machine 100 is configured to complete the autonomous tasks without requiring additional input from the operator.

Machine 100 is also configured to be manually controlled by an operator that is not on/in or at the machine. Manual remote control of machine 100 may provide a number of benefits over and above the typical in-situ manual control of the machine and machine 100 operating autonomously to execute predetermined tasks. For example, there are many situations where machine 100, while operating autonomously, may need to be positioned to start a task or transported from one completed autonomous task to a starting position of a new autonomous task. In such situations, completion of one or more tasks may be substantially improved in efficiency, time, etc. by a remote operator being able to manually control machine 100 in conjunction with or separate from autonomous tasks being executed by the machine without operator control.

Remote control console 101 is wirelessly connected to machine 100. In some examples, machine 100 and console 101 each include wireless transceivers and/or wireless network adaptors to communicate information, data, commands, signals indicative of instructions or other functions, etc. between the machine and console. The wireless communication between machine 100 and console 101 can include traditional RF communication capabilities at one or more frequencies, and can also include higher bandwidth communication via wide or local area communication networks using, for example, WiFi or another standard or proprietary communication standard/protocol. Remote control console 101 can therefore be configured to be arranged remotely from but in relative close proximity to machine 100, like at a particular job site. And, remote control console 101 can be configured to be arranged further remotely from machine 100, like at a central operations center or other location remote from the job site at which machine 100 is located.

FIG. 2A is a schematic diagram depicting an example remote manual and autonomous machine control system 200 in accordance with this disclosure. In FIG. 2A, system 200 includes work machine 100 and remote control console 101. Additionally, work machine 100 includes first wireless communication module 202 and remote control console 101 includes first user interface 204 and second user interface 206. First wireless communication module 202 of work machine 100 includes wireless transceiver 208 and wireless network adaptor 210.

First user interface 204 of remote control console 101 can include one or more input devices configured to receive input from the operator related to autonomous tasks of work machine 100 and one or more output devices configured to output information related to the autonomous tasks to the operator. In the example of FIG. 2A, first user interface 204 includes a touchscreen display device, which is configured to output autonomous task information to the operator, who can monitor, review, change, save, etc. such information via the same touchscreen display device of first user interface 204.

For example, FIG. 2B depicts first user interface 204 in more detail, including touchscreen display 212 and graphical user interface (GUI) 214. GUI 214 is configured to allow an operator to control various aspects of autonomous tasks executed by machine 100. GUI includes a graphical presentation of various aspects of operation of machine 100 in executing an autonomous task. For example, GUI 214 can include interface elements like element 215, which presents information graphically like an autonomous task plan or a visual depiction of machine 100 traversing terrain to process an area. Additionally, user interface controls and other visual indicators and/or controls can be presented in side trays 216 and 218. First user interface 204 and other such example user interfaces for managing and executing autonomous tasks on machine 100 can include more or fewer graphical elements, as well as other user interface elements not specifically depicted in this example.

The operator of machine 100 can use first user interface 204 to control a number of aspects of autonomous tasks, including, for example, reviewing and selecting from a list of available tasks for machine 100 to complete. Such lists or databases of autonomous tasks may be loaded/saved locally on first user interface 204, e.g. on storage media of touchscreen device 212, or such data/information may be downloaded from a remote/cloud server/network system to which remote control console 101 can be connected and configured to communicate. The operator of machine 100 can also select a particular task, review and change parameters/characteristics of the task, command machine 100 to initiate a task, as well as command machine 100 to cease a task, as examples.

Referring again to FIG. 2A, second user interface 206 can include one or more input devices usable by the operator to manually control operation of work machine 100. For example, FIG. 2C depicts second user interface 206 in more detail, including machine drive (e.g., propel and steering) control 220 and implement control 222. Machine drive control 220 and implement control 222 are examples of input control devices included in second user interface 206, the articulation of which by the operator causes a corresponding remotely manually controlled articulation (or other action or change of state) of work machine 100 and machine implement 106.

Example second user interface 206 includes a number of other input control devices for controlling machine braking, engine start/stop, engine gearing and/or speed control, machine lights, horn, and emergency stop, as examples. In other examples according to this disclosure, a remote manual machine control interface can have more or fewer input controls than example second user interface 206, as well as the individual input control design and function may vary from example to example. Second user interface 206 for remote manual control of machine 100 can include multiple clusters of controls. For example, in FIG. 2C, machine drive control 220 and implement control 222 are on a central control cluster and additional controls are provided on two laterally arranged control clusters 224 and 226. In other examples, the position, layout, form, number, etcetera of input controls can be different than example second user interface 206. Additionally, second user interface 206, in addition to input devices, can include one or more output devices. For example, second user interface 206 can include one or more lights and/or audio outputs for outputting indications of various aspects of machine 100 operation and/or state.

Referring to FIG. 2A, remote control console 101 includes second wireless communication module 228. Second wireless communication module 228 of remote control console 101 is configured for wireless communication with first wireless communication module 202 of work machine 100. In this example, first user interface 204 communicates with machine 100 over first wireless channel 230 and second user interface 206 communicates with machine 100 over second wireless channel 232. In one example, first wireless channel 230 can include a radio frequency (RF) channel configured for wireless communication between a wireless transceiver 234 of first wireless communication module 202 of machine 100 and a wireless transceiver of second wireless communication module 228 of remote control console 101. For example, remote control console 101 can include a wireless transceiver communicatively connecting first user interface 204 to work machine 100 and configured to operate in an ISM band at or about 900 megahertz and/or at or about 2.4 gigahertz.

Second wireless channel 232, on the other hand, can include local area networking connections like, for example, WiFi for high bandwidth wireless communication between a wireless network adaptor 236 of first wireless communication module 202 of machine 100 and a wireless network adaptor of second wireless communication module 228 of console 101. Remote control console 101 can also be configured for wide area communication, including, for example, communication between console 101 and cloud/network servers or other devices, from which an operator can download or upload autonomous task, site planning, machine or other information.

### INDUSTRIAL APPLICABILITY

In operation, work machine 100 and remote control console 101 (or other example remote control consoles in accordance with this disclosure) can be employed in a variety of synergistic ways to accomplish various construction or other tasks. In general, work machine 100 can be configured and equipped to operate without in-situ operator control, whether such operation includes remote manual control of the machine or remote autonomous task control. For example, an operator can employ remote control console 101 to manually propel (and direct/steer) machine 100 into a starting position for a preplanned autonomous task to be completed by the work machine. After properly positioning work machine 100, the operator employs console 101 to cause the work machine to initiate the autonomous task.

While the work machine 100 is executing the autonomous task, the operator uses remote control console 101 to monitor progress of the task by the machine. Additionally, the operator can adjust parameters/characteristics of the autonomous task and/or operation of the work machine 100 to improve the performance of the machine and the quality of the work done thereby. In some cases, the operator may, prior to initiating the autonomous task, change parameters/characteristics of the task using remote control console 101.

As work machine 100 is completing the autonomous task, the machine may encounter an object in the path of the machine. In one example, work machine 100 includes a number of sensors and/or sensor systems for measuring, detecting, or otherwise sensing a number of environmental or other parameters, including detecting objects in the path of the machine. The operator may be monitoring progress of work machine 100 with and be alerted to the detected object in the path of the machine using remote control console 101. The operator can use console 101 in such circumstances to cease work machine 100 from executing the autonomous task so that, for example, the object can be safely removed, after which the task can be reinitiated via commands from console 101.

In some cases, the operator may use first user interface 204 of console 101 to assist in remote manual control of machine 100. For example, although first user interface 204 is generally configured and used for management and execution of autonomous tasks, in some cases, the touchscreen display of first user interface 204 may display, e.g., images of the vehicle and surrounding area/terrain to assist the operator in remotely manually controlling machine 100. For example, the display of first user interface 204 may receive video streams or still pictures of machine 100 from different cameras mounted on the machine and configured to capture and transmit multiple views of the machine. In one case, first user interface 204 may depict a split screen depicting a plurality of images of machine 100, which the operator may use to remotely manually control the machine with second user interface 206 to, for example, avoid an object in the path of the machine. In another example, the operator may use video/still images displayed on first user interface 204 to check blind spots of machine 100 before initiating an autonomous task.

In another example, a single operator may control completion of multiple tasks simultaneously or in parallel using remote control console 101. For example, the operator may employ console 101 in-situ on a first work machine to remotely control a second work machine working in concert with or separate from the first work machine. The operator can, for example, employ console 101 to cause the second work machine to execute an autonomous task. Then, while monitoring, e.g. listening for alarms or alerts, progress of the autonomous task with the console 101, the operator can execute one or more manually locally controlled tasks with the first work machine.

The above detailed description is intended to be illustrative, and not restrictive. The scope of the disclosure should, therefore, be determined with references to the appended claims, along with the full scope of equivalents to which such claims are entitled.

What is claimed is:

1. A work machine remote control console, the console comprising:
at least one wireless communication module configured for wireless communication with a work machine;
a first machine user interface comprising one or more input devices configured to receive input from an operator related to autonomous tasks of the work machine and one or more output devices configured to output information related to the autonomous tasks to the operator; and
a second machine user interface comprising one or more input devices usable by the operator to manually control operation of the work machine,
wherein the first and second user interfaces are configured to receive information from and transmit information to the work machine via the at least one communication module.

2. The console of claim 1, wherein the one or more input devices of the first user interface are configured to receive input from the operator defining one or more characteristics of the autonomous tasks.

3. The console of claim 1, wherein the one or more input devices of the first user interface are configured to receive input from the operator to command the work machine to initiate an autonomous task.

4. The console of claim 1, wherein the one or more input devices of the first user interface are configured to receive input from the operator to command the work machine to cease an autonomous task.

5. The console of claim 1, wherein the one or more output devices of the first user interface comprises a display device configured to output information related to the autonomous tasks to the operator.

6. The console of claim 1, wherein the one or more input devices and the one or more output devices of the first user interface comprises a touchscreen device configured to receive input from and generate output to the operator.

7. The console of claim 1, wherein the one or more input devices of the second user interface comprises one or more operator controls, the articulation of one or more of which by the operator causes a corresponding remotely manually controlled articulation of the work machine.

8. The console of claim 7, wherein the one or more operator controls comprises at least one of a machine propel control, a machine steering control, a machine power control, a machine brake control, a machine gear control, and a machine implement control.

9. The console of claim 1, wherein the at least one wireless communication module comprises:
a wireless transceiver communicatively connecting the first user interface to the work machine; and
a wireless network adaptor communicatively connecting the second user interface to the work machine.

10. The console of claim 1 associated with and configured to control only one work machine.

11. A method of remote manual and autonomous control of a work machine, the method comprising:
executing, by a remote control console, at least one of a remotely manually controlled task and an autonomous task with the work machine, the remote control console comprising:
at least one wireless communication module configured for wireless communication with a work machine;
a first machine user interface comprising one or more input devices configured to receive input from an operator related to autonomous tasks of the work machine and one or more output devices configured to output information related to the autonomous tasks to the operator; and
a second machine user interface comprising one or more input devices usable by the operator to manually control operation of the work machine,
wherein the first and second user interfaces are configured to receive information from and transmit information to the work machine via the at least one communication module.

12. The method of claim 11, wherein the one or more input devices of the first user interface are configured to receive input from the operator defining one or more characteristics of the autonomous tasks.

13. The method of claim 11, wherein the one or more input devices of the first user interface are configured to receive input from the operator to command the work machine to initiate an autonomous task.

14. The method of claim 11, wherein the one or more input devices of the first user interface are configured to receive input from the operator to command the work machine to cease an autonomous task.

15. The method of claim 11, wherein the one or more output devices of the first user interface comprises a display device configured to output information related to the autonomous tasks to the operator.

16. The method of claim 11, wherein the one or more input devices and the one or more output devices of the first user interface comprises a touchscreen device configured to receive input from and generate output to the operator.

17. The method of claim 1, wherein the one or more input devices of the second user interface comprises one or more operator controls, the articulation of one or more of which by the operator causes a corresponding remotely manually controlled articulation of the work machine.

18. The method of claim 17, wherein the one or more operator controls comprises at least one of a machine propel control, a machine steering control, a machine power control, a machine brake control, a machine gear control, and a machine implement control.

19. The method of claim 11, wherein the at least one wireless communication module comprises:
a wireless transceiver communicatively connecting the first user interface to the work machine; and
a wireless network adaptor communicatively connecting the second user interface to the work machine.

20. The method of claim 11, wherein the remote control console is associated with and configured to control only one work machine.

21. The method of claim 11, wherein executing, by a remote control console, at least one of a remotely manually controlled task and an autonomous task with the work machine comprises:
initiating, by the remote control console, a first autonomous task with the work machine;
detecting an object in the path of the work machine; and
ceasing, by the remote control console, the first autonomous task.

22. The method of claim 21, further comprising reinitiating, by the remote control console, the first autonomous task with the work machine.

23. The method of claim 11, wherein executing, by a remote control console, at least one of a remotely manually controlled task and an autonomous task with the work machine comprises:
manually propelling, by the remote control console, the work machine into a first starting position for a first autonomous task; and
initiating, by the remote control console, the first autonomous task with the work machine from the first starting position.

24. The method of claim 23, further comprising:
manually propelling, by the remote control console, the work machine into a second starting position for a second autonomous task; and
initiating, by the remote control console, the first autonomous task with the work machine from the second starting position.
